(19) United States
(12) Patent Application Publication
(10) Pub. No.: US 2022/0356681 A1
(43) Pub. Date: Nov. 10, 2022

(54) GROUND ENGAGING TOOL ATTACHMENT ARRANGEMENT

(71) Applicant: ROCKS GONE PTY LTD, Kewdale, Western Australia (AU)

(72) Inventor: Timothy Gordon PANNELL, Kewdale, Western Australia (AU)

(73) Assignee: ROCKS GONE PTY LTD, Kewdale, Western Australia (AU)

(21) Appl. No.: 17/755,114

(22) PCT Filed: Oct. 21, 2020
(86) PCT No.: PCT/AU2020/051136

§ 371 Date: Apr. 21, 2022

(30) Foreign Application Priority Data
Oct. 22, 2019 (AU) 2019903976

(51) Int. Cl. E02F 9/28; E02F 5/32

(52) U.S. Cl. CPC E02F 9/2833; E02F 9/2875; E02F 5/32

(57) ABSTRACT

Provided is an arrangement that attaches a ground-engaging tool (GET) to an adapter on support structure of ground/earth engaging/conditioning apparatus. A retainer is in a recess of the adapter. A fastener is received through the GET aperture and into the adapter aperture. The head of the fastener can be within a recess of the GET. The recess can be multi lobed/shaped to receive the retainer and prevent rotation or other torsional/lateral deformation of the retainer when tightening/inserting the fastener. A fastener has a first threaded portion adjacent the head of the fastener and a second threaded portion along a shaft portion of the fastener extending distal from the head. The first threaded portion can be wider and/or of a more coarse thread pitch than the second threaded portion.

### FIELD OF THE INVENTION

The present invention relates to an arrangement for attaching a ground engaging tool (GET) for use with earth conditioning apparatus and/or rock conditioning apparatus (such as for breaking or scarifying rock in the ground).

### BACKGROUND TO THE INVENTION

It is desirable to improve soil conditions in different applications. Rock crushing is sometimes performed for this purpose.

Where cap rock is present at or immediately below soil surface, scarifying can remove rock in one or more passes by scarifying apparatus.

The reliability, ease and speed of rock crushing and/or scarifying are often considered, particularly for economic and/or deadline factors.

Rotary drum type rock grinders can be slow and expensive to purchase, maintain and operate, and do not cope well with uneven ground or with soil/mixed rock and soil situations. Productivity is relatively low. Use of such rotary machines can make the land difficult to develop without the added costs of clean up and repair to the site.

An alternative piece of earth conditioning apparatus used for breaking or scarifying rock, as described in Australian patent application by the present applicant and published as AU 2014203634, copes well with certain rock and soil mix conditions. The contents of AU 2014203634 are incorporated herein by reference.

Another type of earth conditioning apparatus, as described in pending international (PCT) application PCT/AU2019/050584 by the present applicant, provides an improved soil conditioning apparatus, the contents of which are incorporated herein by reference.

A ripper is an alternative piece of apparatus for breaking up or lifting rock to the surface. The ripper can be used with conventional machines (such as attached to the rear of a tractor) and uses teeth that engage into the ground to break up or drag rock to the surface for removal. The teeth leave the rock ripped up in large regular pieces or dragged up whole to the surface and need further processing or removal.

However, the teeth become worn and/or shear off prematurely. Mounting arrangements for the teeth can be difficult to access or use to replace teeth once the machine has been in use where soil/rock clogs or deforms fixtures and prevents ready access to mounting components.

It will be appreciated that one or more forms of the present invention advantageously provides a convenient arrangement for mounting and/or replacing one or more ground engaging teeth (GET) for use with mobile earth conditioning apparatus or other ground/earth engaging apparatus.

It is against this background and the problems and difficulties associated therewith that the present invention has been developed.

### SUMMARY OF THE INVENTION

An aspect of the present invention provides an arrangement for attaching a ground-engaging tool (GET) for use with ground/earth engaging/conditioning apparatus, the arrangement including an adapter for receiving a GET, a GET and a fastener arrangement configured to removably attach the GET to the adapter.

Preferably the adapter is attached to the ground/earth engaging/conditioning apparatus.

The earth engaging apparatus can be or be part of an ground/earth engaging/conditioning apparatus, such as for breaking or removing rocks present in the ground.

The adapter can include at least one adapter aperture for receiving a fastener.

The ground-engaging tool (GET) may be or may include a tooth. The tooth may have one or more picks e.g. at least one pointed end to the respective tooth. The pick or each pick may be or include hardened steel.

The GET may include at least one GET aperture to receive therein the fastener. For example, the GET may be received at least partially over or partially in the adapter, and the fastener passed into the GET and the adapter to fasten the GET and the adapter together such that the GET is releasably retained on the adapter.

The adapter may be mounted on, or form part of, a support arrangement, such as a frame, having multiple said GETs.

Preferably, the fastener may be retained fastened by at least one retainer, by a thread of the fastener engaging with the adapter, or a combination of retainer and thread engagement.

The at least one retainer may include at least one resilient means, such as a resilient washer.

The fastener may be termed a ‘locking pin’ i.e. that locks the GET to the adapter.

Preferably the fastener may have at least one coarse pitch, multi-start thread, which enables quick installation/removal of the GET to/from the adapter.

The fastener may include multi-start extract grooves (thread/helix) in the shaft/shank of the fastener to help break dirt/silt packing between the shaft/shank and adaptor to aid removal of the fastener and therefore of the GET for replacement.

The fastener may have an inset drive head, such as an inset hexagonal (‘hex’) head drive means e.g. to receive a suitably shaped driver, such as an Allen key.

Preferably the fastener includes or is formed of hardened and/or tempered steel.

The GET may include a socket to receive a portion of the adapter therein. The fastener may pass through a side wall of the GET (such as through the GET aperture) and into the adapter aperture, preferably the fastener engaging in threaded configuration with corresponds thread son the adapter and optionally the GET.

The fastener may be restrained against lateral movement once fastened, such as by engagement with the retainer. Such restraint may be by way of the thread of the fastener engaging with the retainer and/or by resilient engagement with the retainer.

The retainer may be or may include a point lock device. The retainer may include multiple lobes that fit into a recess in the adapter.

Preferably an outer end of the fastener, such as a drive head end for receiving a driver for fastening or releasing the fastener, may be flush or near flush with an outer surface of the GET adjacent the GET aperture.

Preferably, the retainer includes or is formed of a polymer material, Made of polyurethane (or other suitable polymers/elastomers). Tough & flexible grips thread to resist turning by friction.

More than one retainer may be employed to retain the fastener, or the retainer may include multiple parts. For example, multiple retainers or retainer elements may be stacked together or otherwise brought together, or segmented/partial retainers may be combined to form a single retainer.

Preferably, the retainer may be held or reside in place between the adapter & ground engaging tool.

It will be appreciated that the retainer, being between the adapter and the GET avoids damage from impact/use of the GET whilst retaining the fastener.

The retainer therefore can serve its retaining function for longer by avoiding abrasion, ingress of dirt and weathering, and avoid damage that might otherwise prevent the fastener from being released when the GET is due for replacement. The retainer can therefore be easier to replace once the GET is removed.

The ground engaging tool (GET) may have at least one GET aperture to receive the fastener. The GET may have more than one GET aperture, such as at either side thereof.

The GET apertures may receive a fastener from each side i.e. more than one fastener being used to secure the GET to the adapter, or there may be a single fastener passing through one GET aperture, through the adapter and into another GET aperture at an opposite side of the GET.

The other GET aperture may be a blind aperture i.e. the fastener may pass into it but the aperture is not open ended, such that a side wall of the GET is not pierced by the other GET aperture.

The GET aperture or apertures may each be threaded internally to engage with the fastener thread or may both be so threaded.

Preferably, the GET aperture is sufficiently wide to receive therein the head of the fastener such that the head of the fastener sits flush with or below (recessed into) an outer surface of the GET on one side of the GET. Fasteners applied from both sides of the GET may sit flush or recessed accordingly.

The fastener may include at least one thread, preferably multiple threads, such as on or more helical threads around a shaft of the respective fastener. The multiple threads may be 180° apart i.e. diametrically opposed about the shaft.

The retainer can be provided in a recess in the adapter or a recess in the GET, or in a recess in each of the adapter and the GET.

The fastener may include multi-start extract grooves or threads in a shaft/shank of the fastener.

The arrangement may be provided as a kit of parts.

A method releasable attachment of a ground engaging tool (GET) to ground/earth engaging/conditioning apparatus includes the steps of: providing a retainer on or in an adapter attached to the ground/earth engaging/conditioning apparatus, mounting the GET onto the adapter, the GET covering the retainer; and fastening the GET to the adapter and therefore to the earth conditioning apparatus by a fastener passing through an aperture of the GET, through the retainer and into an aperture of the adapter.

The method may include the retainer restricting or preventing longitudinal movement of the fastener along a longitudinal axis of the fastener unless the fastener is rotated for release.

The retainer may be used to restrict or prevent lateral movement of the fastener from the GET unless the fastener is rotated for release.

Preferably, the retainer resiliently grips or holds the fastener.

A ground engaging tool system may include an adapter for receiving a GET, a GET and a fastener arrangement configured to removably attach the GET to the adapter.

The ground engaging tool system may include one or more of the embodiments of the arrangement described above and as follows.

### BRIEF DESCRIPTION OF THE DRAWINGS

One or more embodiments of the present invention will hereinafter be described with reference to the accompanying Figures, in which:

FIG. 1 shows an exploded view of an embodiment of the present invention relative to a support structure, such as of an earth conditioning apparatus.

FIGS. 2a to 2c show perspective, side view and an end sectional view of an adapter for receiving a ground engaging tool, according to an embodiment of the present invention.

FIGS. 3a to 3f show features of a fastener according to an embodiment of the present invention.

FIGS. 4a to 4e show features of a retainer according to an embodiment of the present invention.

FIGS. 5a and 5b show perspective and side sectional views of a ground engaging tool (GET) according to an embodiment of the present invention.

FIGS. 6a to 6c show views of an adapter, GET, fastener and retainer according to an embodiment of the present invention.

FIG. 7 shows an alternative embodiment of the present invention.

FIG. 8 shows a side view of an earth conditioning apparatus incorporating an arrangement for attaching a ground-engaging tool (GET) according to an embodiment of the present invention.

### DESCRIPTION OF PREFERRED EMBODIMENT(S)

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

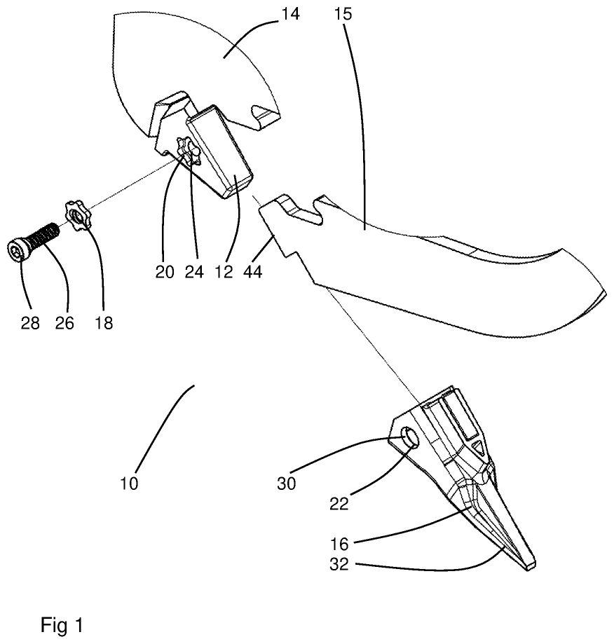

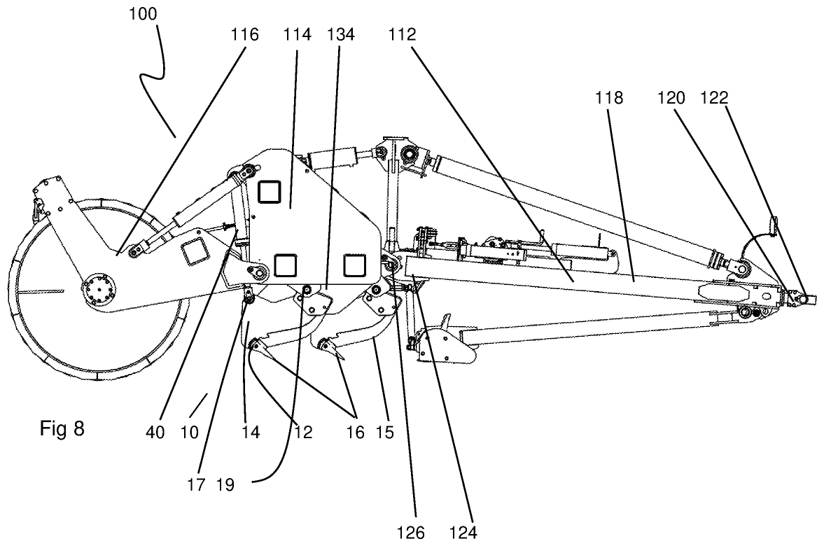

FIG. 1 shows an exploded view of arrangement or system 10 for attaching a ground-engaging tool (GET) for use with earth conditioning apparatus 100 (FIG. 8), according to an embodiment of the present invention.

It will be appreciated that whilst the following particular embodiments are described with reference in places to earth conditioning apparatus, the present invention finds application with other ground/earth engaging apparatus.

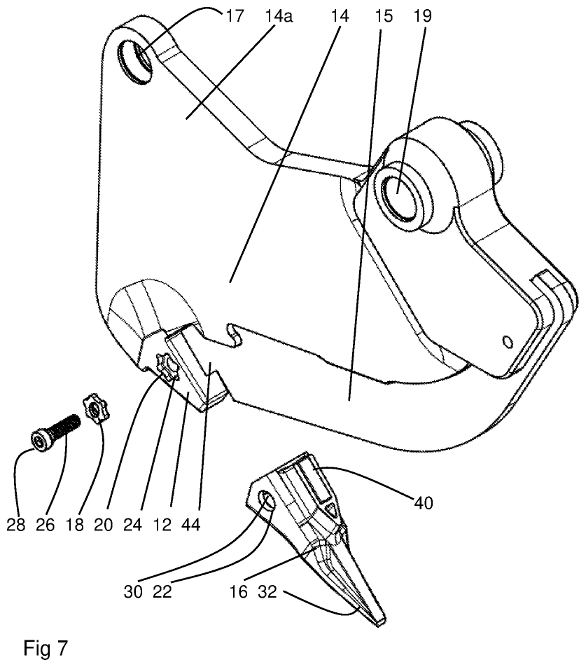

An adapter 12 is attached to a support structure 14 of an earth conditioning apparatus. A wear part 15 protects the support structure from rock impacts when in use engaging into the ground. The support structure is pivoted at a main pivot 19 and connects to an actuator 40 via a pivot connection 17 for lowering and raising the tine and associated ground engaging tool (GET) 16 about the main pivot 19 (see FIGS. 7 and 8).

The GET 16 of the assembly 10 is received by the adapter. As shown, the GET fits onto the adapter. However, it will be appreciated that other arrangements are envisaged, such as the GET fitting into, or otherwise engaging with, the adapter.

According to an alternative, the GET may be retained on a support structure with an integral adapter, such as a cast/forged tine/support structure e.g. as shown by exemplary embodiment in FIG. 7. That is, the adapter may form an integral part of the support structure or may be attached thereto, such as by welding.

It will be understood that the adapter provides a mount for releasable attachment of the GET.

A retainer 18 resides in a recess 20 in the adapter. The GET is then received by the adapter. A GET aperture 22 in the side of the GET aligns with an adapter aperture 24 in the adapter.

A fastener 26 is received through the GET aperture and into the adapter aperture.

Preferably, the head 28 of the fastener 26 is at least partially, preferably completely, within a recess 30 of the GET.

The retainer 18 can be shaped to locate into a corresponding shaped said recess 20 of the adapter. Preferably the retainer and recess are multi-sided so as to prevent rotation of the retainer during screwed thread fastening of the fastener into/through the GET/adapter.

The GET provides a pick/tine/tooth tip 32 that can be lowered/raised by the support structure when the earth conditioning apparatus is in use or for transport.

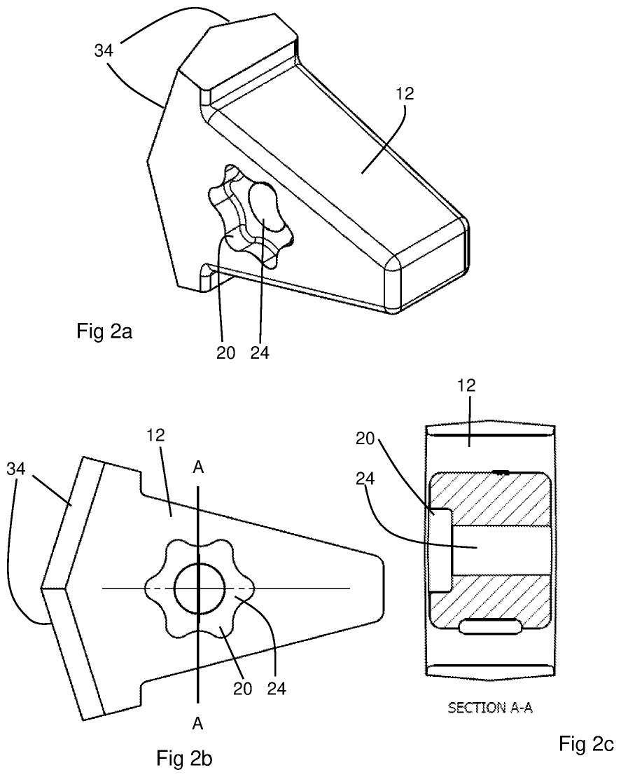

As shown in FIGS. 2a to 2c, the adapter 12 has faces for welding attachment to the support structure.

The recess 20 in the side of the adapter is multi lobed/shaped to receive the retainer (18, FIG. 1) and prevent rotation or other torsional/lateral deformation of the retainer when tightening/inserting the fastener.

Preferably the adapter aperture 24 passes completely through the adapter, e.g. so that the fastener can pass through to the opposite side of the adapter and engage into the GET. Alternatively, separate fasteners can be applied from either side of the GET into the adapter.

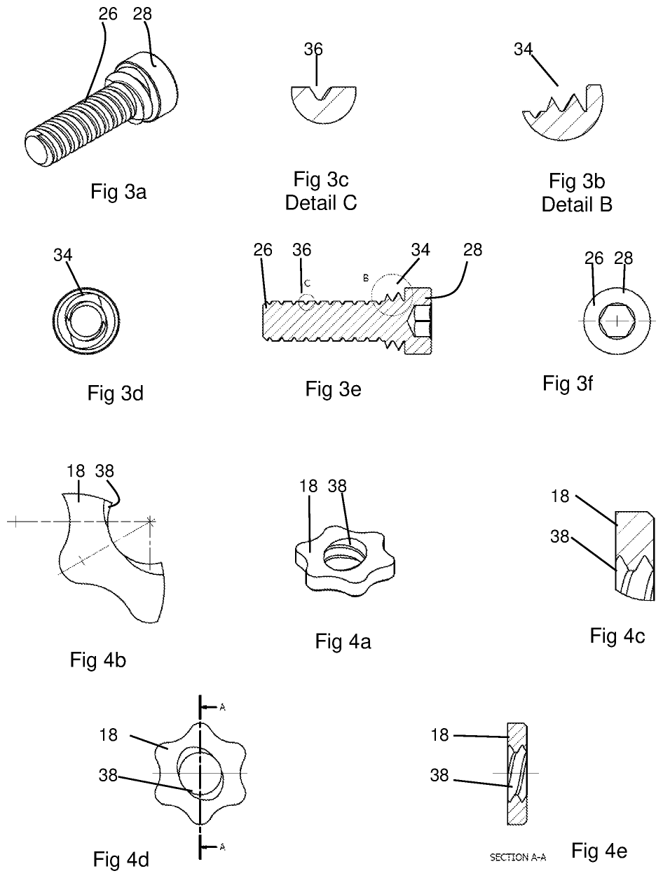

FIGS. 3a to 3f show features of the fastener 26.

Preferably the fastener 26 includes a first threaded portion 34 adjacent the head 28 of the fastener 26.

The fastener 26 may also have a second threaded portion 36 along a shaft portion of the fastener extending distal from the head.

The first threaded portion can be wider and/or of a more coarse thread pitch than the second threaded portion.

Preferably the first threaded portion engages with the retainer. The retainer can be formed of or include a resilient material, such as a polymer (e.g. polyurethane). Such a resilient material can deform sufficiently to enable the fastener to pass into the adapter to retain the GET on the adapter, but have sufficient grip on the fastener to resist release of the fastener during working use of the GET whilst allowing a tool, such as an Allen key or other driver, to release the fastener.

A deep thread of the first threaded portion provides a relatively large surface area for grip/friction contact with the retainer.

A coarse thread of the first threaded portion enables the fastener to tighten or release within small number of rotations of the fastener, and preferably within one rotation, and more preferably less than one full rotation e.g. half of a full rotation.

The first threaded portion and/or the second threaded portion may be single threaded or multi-threaded, such as twin spiral/helical threads set 180° apart. Other numbers of threads are envisaged, such as three threads set 120° apart.

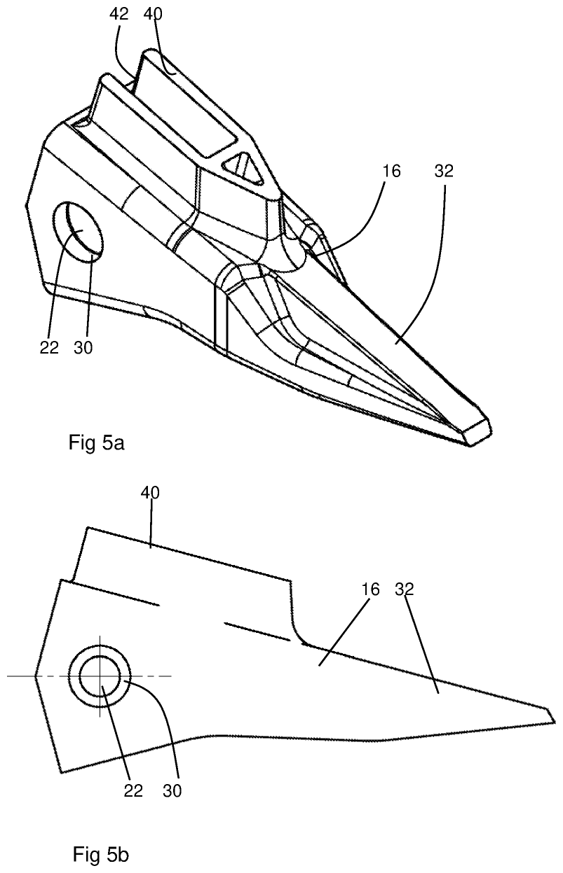

As shown in FIGS. 4a to 4e, the retainer 18 can include an internal thread 38 to engage with the first threaded portion. Preferably the thread of the retainer is coarse and matches the coarse thread of the first threaded portion of the fastener.

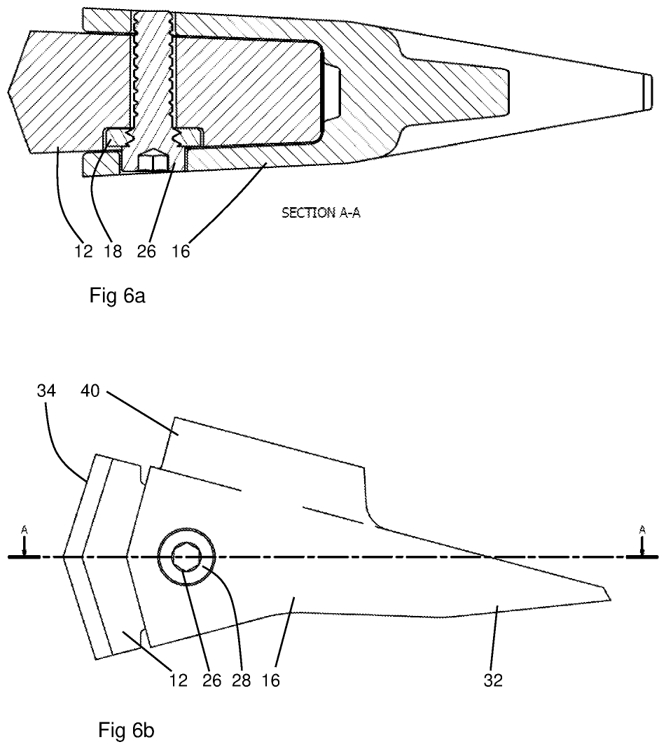

FIGS. 5a and 5b show features of the ground engaging tool (GET) 16. The GET can include an engagement portion 40 for engaging with the support structure 14. The engagement portion can include a recess or slot 42 for receiving a part 44 (FIG. 1) of the support structure 14. This engagement can help steady the GET and help to reduce twist when digging into soil and/or rock.

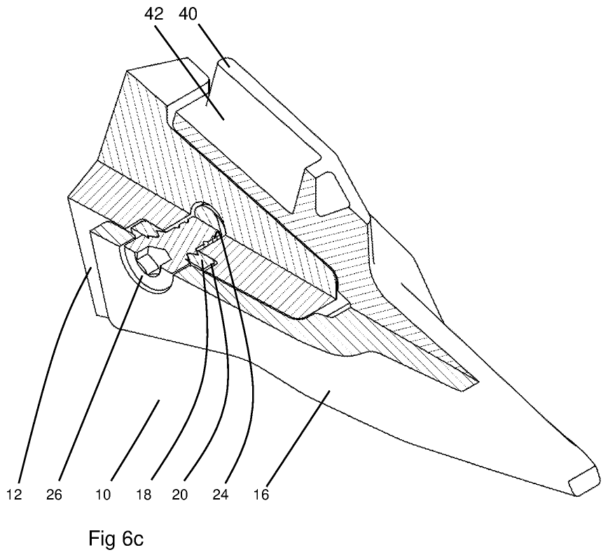

FIGS. 6a to 6c show views of the ground-engaging tool (GET) attachment arrangement with the GET 16 and adapter 12 assembled and held together by the fastener 26, with the fastener retained by the retainer 18.

The fastener can include one or more threads 36, which may be employed to help remove dirt/grit that might otherwise bind the fastener in the GET/adapter or prevent insertion of the fastener therein.

The thread 36 may threadingly engage with a thread of the adapter and/or of the GET, but may alternatively not so engage, rather, the thread 36 of the fastener may be used to help remove the dirt/grit e.g. as a type of reamer to clean out the apertures.

It will be appreciated that removal of the GET from the adapter is generally a reversal of the attachment procedure.

Preferably the retainer is replaced each time the GET is replaced. However, the retainer could be reused if no replacement retainer is to hand.

FIG. 7 shows an alternative form of the present invention with the adapter 12 integral to the support structure i.e. such as by casting or forging, rather than welding attachment shown in FIG. 1. A wear part 15 protects the support structure from rock impacts when in use engaging into the ground. The support structure is pivoted at a main pivot 19 and connects to an actuator 40 via a pivot connection 17 for lowering and raising the tine and associated ground engaging tool (GET) 16 about the main pivot 19 (see also FIG. 8).

FIG. 8 shows a side view of an earth conditioning apparatus 100 incorporating arrangements 10 for attaching ground-engaging tools (GETs) according to an embodiment of the present invention. The earth conditioning apparatus is for use by engaging into the earth behind a vehicle (not shown) and removing and/or breaking up rock (such as by ripping and/or crushing).

The earth conditioning apparatus 100 includes a support structure 14 supporting a number of adapters 12. The adapters support a number of ground engaging tools (GET) 16.

The earth conditioning apparatus 100 includes a front drawbar arrangement 112, an intermediate ground engaging tool arrangement 114 and a rear rotary device 116.

The drawbar arrangement 112 includes a drawbar 118, a hitch 120 at a leading end 122 of the drawbar to attach the system to a prime mover (not shown).

A pivot arrangement 126 is provided at the trailing end 124 of the drawbar.

The ground engaging tool arrangement 114 includes a frame 134 supporting the ground-engaging tools (GETs) 16.

An actuator 40 can be controlled to raise or lower the respective ground engaging tool(s) 16 depending on desired depth that the respective ground engaging tool is required to engage into the ground (which can depend on ground type, proportion of soil to rock, rock type, wet/dry ground, depth required to operate at, power of the prime mover etc.).

A rotary device 116 can be attached to trail behind the ground engaging tool arrangement 114. The rotary device 116 can include a roller or drum, such as of a solid (preferably hollow) body with ribs thereon, or can be of spaced discs or wheels or ribs creating channels therebetween.

The rotary device can include a slotted or ribbed said drum to act as a crushing drum for being rolled over rock/earth that has been broken up by the ground engaging tools 16.

It is to be understood that, if any prior art is referred to herein, such reference does not constitute an admission that the prior art forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An arrangement for attaching a ground-engaging tool (GET) for use with a ground engaging or earth conditioning apparatus, the arrangement comprising:
an adapter for receiving a GET;
a GET; and
a fastener arrangement configured to removably attach the GET to the adapter.

2. The arrangement of claim 1, wherein:
the adapter is part of a cast or forged support structure of the ground engaging or earth conditioning apparatus; or the adapter is weldingly secured to a support structure of the ground engaging or earth conditioning apparatus.

3. (canceled)

4. The arrangement of claim 1 wherein the adapter comprises at least one adapter aperture for receiving the fastener.

5. The arrangement of claim 1 wherein the GET comprises at least one aperture to receive the fastener.

6. The arrangement claim 1, wherein the fastener is retained fastened by at least one retainer.

7. The arrangement of claim 6, wherein the at least one retainer comprises at least one resilient means.

8. The arrangement of claim 6, wherein the at least one retainer is provided in a space between the adapter and the GET.

9. The arrangement of claim 6, wherein the at least one retainer is provided in a recess in the adapter or a recess in the GET, or in a recess in each of the adapter and the GET.

10. The arrangement of claim 6, wherein the at least one retainer is covered by the GET when the GET is mounted to the adapter.

11. The arrangement of claim 6, wherein the at least one retainer comprises a polymer material.

12. The arrangement of claim 6, wherein the at least one retainer comprises a point lock device or has multiple lobes that fit into a recess in the adapter.

13. The arrangement of claim 6, wherein the at least one retainer has at least one internal thread.

14. The arrangement of claim 13, wherein the at least one internal thread comprises multiple helical or spiral threads.

15. The arrangement of claim 1, wherein:
the fastener comprises multi-start extract grooves or threads in a shaft/shank of the fastener; and/or
the fastener is restrained against lateral movement once fastened.

16. (canceled)

17. The arrangement of claim 1, provided as a kit of parts.

18. A method of releasably attaching a ground engaging tool (GET) to a ground engaging or earth conditioning apparatus, the method comprising the steps of:
providing a retainer on or in an adapter attached to the ground engaging or earth conditioning apparatus,
mounting the GET onto the adapter, the GET covering the retainer; and
fastening the GET to the adapter and therefore to the ground engaging or earth conditioning apparatus with a fastener passing through an aperture of the GET, through the retainer and into an aperture of the adapter.

19. The method of claim 18, wherein:
the retainer restricts or prevents longitudinal movement of the fastener along a longitudinal axis of the fastener unless the fastener is rotated for release; and/or
the retainer restricts or prevents lateral movement of the fastener from the GET unless the fastener is rotated for release.

20. (canceled)

21. The method of claim 18, wherein the retainer resiliently grips or holds the fastener.

22. A ground engaging tool system comprising:
an adapter for receiving a GET;
a GET, and
a fastener arrangement configured to removably attach the GET to the adapter.

23. The ground engaging tool system of claim 22, comprising an arrangement for attaching a ground-engaging tool (GET) for use with a ground engaging or earth conditioning apparatus, the arrangement comprising:
an adapter for receiving a GET;
a GET; and
a fastener arrangement configured to removably attach the GET to the adapter.
